(19) United States
(12) Patent Application Publication
(10) Pub. No.: US 2024/0303567 A1
(43) Pub. Date: Sep. 12, 2024

(54) INTELLIGENT LOGISTICS TRUCK SCHEDULING SYSTEM

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,721

(22) Filed: Mar. 7, 2023

(51) Int. Cl. G06Q 10/0631; G06Q 10/083

(52) U.S. Cl. CPC G06Q 10/06315; G06Q 10/083

(57) ABSTRACT

An intelligent logistics truck scheduling system includes a truck service section for receiving client demand. The truck service section includes a demand judgment module and a network module. A truck scheduling section performs data transmission with the truck service section. The truck scheduling section includes a truck company database, an idle truck monitoring module, a truck distance judgment module, a truck selection module, and a truck assignment module. A truck tracking section performs data transmission with the truck service section. A storage service section performs data transmission with the truck service section. The storage service section includes a storage demand judgment module. The intelligent logistics truck scheduling system can quickly dispatch trucks and drivers, and meet needs of storage demands of the clients.

### BACKGROUND OF THE INVENTION

### 1. Fields of the Invention

The present invention relates to an intelligent logistics truck scheduling system capable of quickly finding suitable trucks and drivers for pickup and delivery.

### 2. Descriptions of Related Art

Logistics systems are of high importance in today's society. This is because with the advancement of technology, e-commerce platforms, mobile stores and other online shopping techniques have become mature, resulting in a high degree of dependence on online shopping. This has also led to a proportional increase in the workload of logistics. The impact caused by the deficiencies in previous logistics systems has become more pressing and in need of resolution.

For example, traditional truck scheduling operations require multiple means of communication such as email, phone, and text messages to repeatedly communicate with clients about truck pickup times and locations. At the same time, truck scheduling companies also need to search and contact relevant trucks and drivers through various platforms, plan and arrange for trucks and drivers to arrive at designated times and locations to perform pickup and transportation operations. This method of operation is inefficient, time-consuming and labor-intensive, and significantly affects the speed of data processing and operational operations.

The present invention intends to provide an intelligent logistics truck scheduling system to eliminate the shortcomings mentioned above.

### SUMMARY OF THE INVENTION

In order to improve the problems of conventional truck scheduling systems, the truck service section includes a truck scheduling section, and the truck scheduling section includes a truck company database, an idle truck monitoring module, a truck distance judgment module, a truck selection module, and a truck assignment module. The truck company database stores all truck and driver information of a truck company so that the truck scheduling section can connect to various truck company networks through the network module of the truck service section. In this way, the idle truck monitoring module can monitor the idle trucks and drivers of various truck companies in real time. The truck distance judgment module is used to judge the distance between the container location and the idle trucks. The truck selection module selects the truck closest to the container location based on the information mentioned above and transmit the corresponding information to the truck assignment module. The truck assignment module sends the command to the selected truck and driver for container pickup and delivery through the internet, and later it can be combined with the truck tracking section to determine the current location of the goods. This invention changes most of the steps in the traditional truck scheduling systems into automation, compared to the past, which relied on manpower to communicate with customers, truck companies, and drivers through various means such as email, telephone, and text message to confirm the time and location of truck pickup, indeed improving the efficiency of the truck scheduling systems.

The present invention relates to an intelligent logistics truck scheduling system and comprises a truck service section for receiving a client demand, and the truck service section includes a demand judgment module and a network module. The demand judgment module judges whether the client has the demand for truck service. The network module is connected with internet. A truck scheduling section performs data transmission with the truck service section. The truck scheduling section includes a truck company database, an idle truck monitoring module, a truck distance judgment module, a truck selection module, and a truck assignment module. The truck selection module selects a truck based on the information feedback from the truck company database, the idle truck monitoring module, and the truck distance judgment module. The truck assignment module then assigns a truck for pickup and delivery. A truck tracking section performs data transmission with the truck service section. A storage service section performs data transmission with the truck service section. The storage service section includes a storage demand judgment module.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow charts of the intelligent logistics truck scheduling system of the present invention, and

FIG. 2 shows the components of the intelligent logistics truck scheduling system of the present invention.

### DETAILED DESCRIPTION OF THE PREFERRED EMBODIMENT

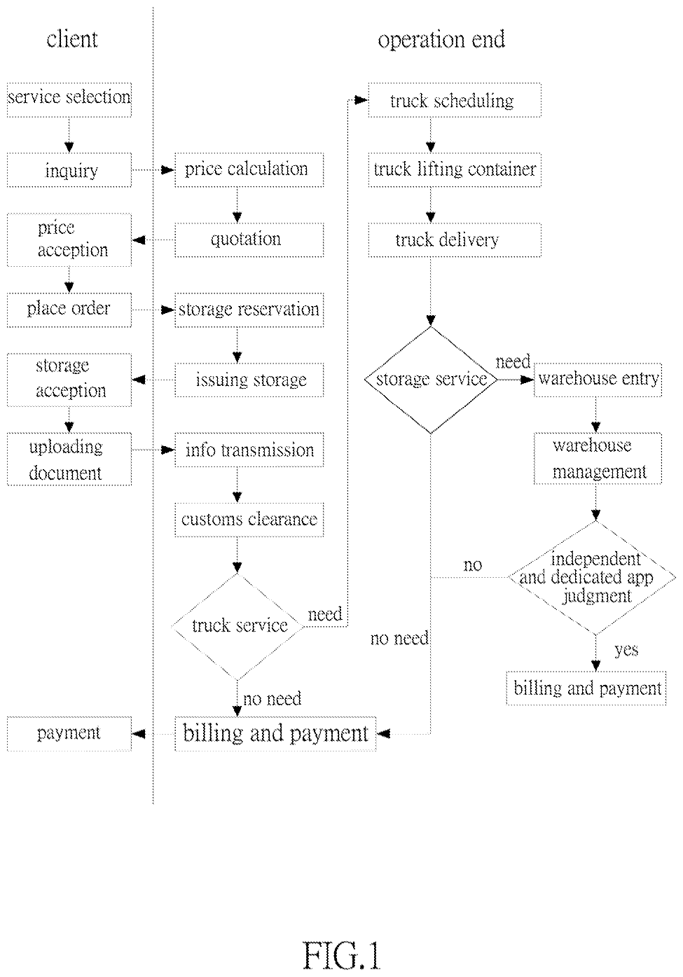

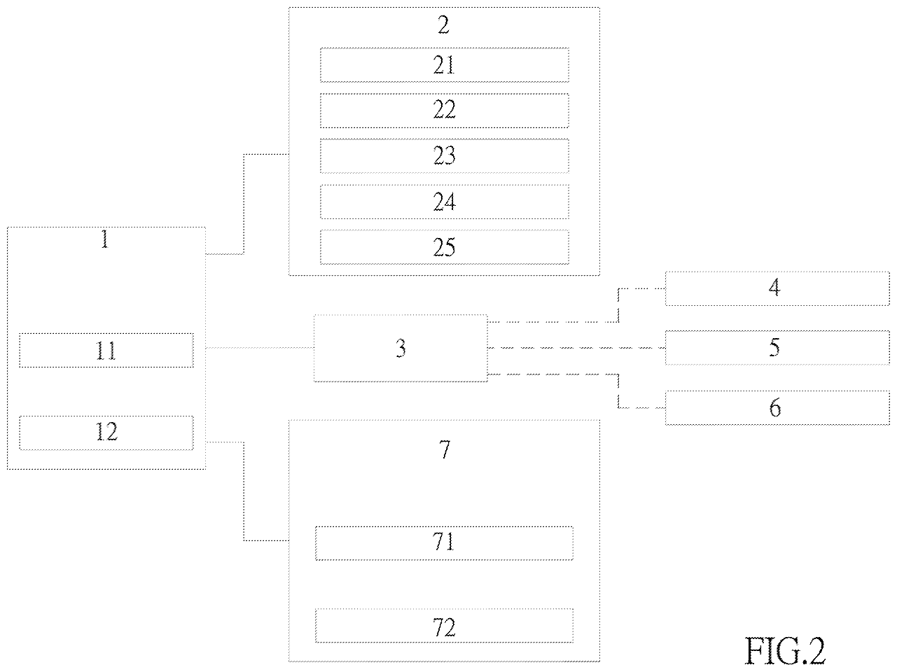

Referring to FIGS. 1 and 2, the intelligent logistics truck scheduling system of the present invention comprises a truck service section 1 for receiving a client's demand, and the truck service section 1 includes a demand judgment module 11 and a network module 12. The demand judgment module 11 judges whether the client has the demand for truck service. The network module 12 is connected with internet. A truck scheduling section 2 performs data transmission with the truck service section 1. The truck scheduling section 2 includes a truck company database 21, an idle truck monitoring module 22, a truck distance judgment module 23, a truck selection module 24, and a truck assignment module 25. The truck selection module 24 selects a truck based on an information feedback from the truck company database 21, the idle truck monitoring module 22, and the truck distance judgment module 23, and a truck is assigned by the truck assignment module 25 for pickup and delivery. A truck tracking section 3 performs data transmission with the truck service section 1. A storage service section 7 performs data transmission with the truck service section 1. The storage service section 7 includes a storage demand judgment module 71.

The actual operation of the truck distance judgment module 23 can be to add a GPS positioning device to each driver, and to periodically and real-timely return the current location, so as to judge the distance between the idle truck and the container pick-up location.

As shown in FIG. 1, the overall operating process of the intelligent logistics truck scheduling system of the present invention, and the purpose of this invention is to optimize the truck service after the customs clearance step. The truck service section 1 includes a demand judgment module 11 which is used to determine whether the client has the need for truck service. If there is such a need, it enters into the truck scheduling step. The truck service section 1 is matched with a scheduling section 2, and the truck dispatch section 2 includes a truck company database 21, an idle truck monitoring module 22, a truck distance judgment module 23, a truck selection module 24, and a truck assignment module 25. The truck company database 21 stores all the information of the truck companies, drivers, so that the truck scheduling section 2 can connect with each truck company network through the network module 12 of the truck service section 1. The idle truck monitoring module 22 can real-time monitor the idle trucks and drivers of each truck company (monitoring each truck company's personnel management system and truck management system), and the truck distance judgment module 23 is used to judge the distance between the container location and the idle trucks (using GPS technology). The truck selection module 24 can select the truck closest to the container location based on the above information and transfer the corresponding information to the truck assignment module 25. The truck assignment module 25 will send the instructions to the selected truck and driver through the internet to carry out the container and delivery. Afterwards, it can be matched with the truck tracking section 3 to determine the current location of the goods. Therefore, most of the steps in the previous truck scheduling systems have been changed to automation in this invention, compared to the past where it was done by manpower through email, phone, SMS, and other methods.

The truck tracking section 3 obtains information about the current location of goods by obtaining information feedback from systems such as the warehousing location information system 4, the cargo receiving and sending location system 5, and the truck transportation location system 6.

During truck delivery, the storage demand judgement module 71 of the storage service section 7 determines if there is a storage demand for the client. If the client has this demand, it will arrange the goods to be stored in the warehouse, and warehouse management. After the storage of the goods in the warehouse is completed, a dedicated storage app judgement module 72 of the storage service section 7 will determine if the storage company has issued an independent and dedicated app (application) and whether the client is using that app. If both are true, an invoice receipt will be issued for that app. If not, an invoice receipt will be issued through the operation end for the client to make payment.

While we have shown and described the embodiment in accordance with the present invention, it should be clear to those skilled in the art that further embodiments may be made without departing from the scope of the present invention.

What is claimed is:

1. An intelligent logistics truck scheduling system comprising:
a truck service section for receiving a demand from a client, the truck service section including a demand judgment module and a network module, the demand judgment module judging whether the client has the demand for truck service, the network module connected with internet;
a truck scheduling section performing data transmission with the truck service section, the truck scheduling section including a truck company database, an idle truck monitoring module, a truck distance judgment module, a truck selection module, and a truck assignment module, the truck selection module selecting a truck based on an information feedback from the truck company database, the idle truck monitoring module, and the truck distance judgment module, the truck assignment module assigning a truck for pickup and delivery;
a truck tracking section performing data transmission with the truck service section, and
a storage service section performing data transmission with the truck service section, the storage service section including a storage demand judgment module.

2. The intelligent logistics truck scheduling system as claimed in claim 1, wherein the storage service section includes a dedicated storage app judgement module.
